(19) United States
(12) Patent Application Publication
(10) Pub. No.: US 2020/0408343 A1
(43) Pub. Date: Dec. 31, 2020

(54) QUICK CONNECTOR ASSEMBLY

(71) Applicant: HS R & A Co.,Ltd., Yangsan-si (KR)

(72) Inventors: Jae Hyeok CHOI, Yangsan-si (KR); Guk Hyun KIM, Yangsan-si (KR); Seung Hoon SUNG, Busan (KR); Min Jun KIM, Yangsan-si (KR)

(73) Assignee: HS R & A Co.,Ltd., Yangsan-si (KR)

(21) Appl. No.: 16/897,954

(22) Filed: Jun. 10, 2020

(30) Foreign Application Priority Data
Jun. 28, 2019 (KR) 10-2019-0077783

(51) Int. Cl. F16L 37/12

(52) U.S. Cl. CPC F16L 37/1225

(57) ABSTRACT

According to various embodiments, a quick connector assembly includes a tube-shaped outer case having a hollow portion therein and an airtight holding member is provided inside the hollow portion and coupled to an outer surface of a coupling case so that the outer case and the coupling case inserted into the hollow portion maintain airtightness each other. A fixing member is detachably fitting-coupled to the outside of the outer case and configured to elastically press and fix the outer surface of the coupling case inserted into the hollow portion.

### CROSS-REFERENCE TO RELATED APPLICATION(S)

This application is based on and claims priority under 35 U.S.C. 119 to Korean Patent Application No. 10-2019-0077783, filed on Jun. 28, 2019, in the Korean Intellectual Property Office, the entire disclosure of which is incorporated herein by reference.

### TECHNICAL FIELD

The disclosure relates to a quick connector assembly, and more particularly, to a quick connector assembly capable of separating a coupling case from an outer case without completely separating a fixing member when separating the coupling case coupled to the outer case.

### BACKGROUND

Various parts are disposed inside a vehicle, and various fluids, such as air, mixture gas, exhaust gas, and fuel, circulate and operate between the parts. For example, in an engine cooling system, an engine and a radiator are provided, and by circulating the coolant in the engine and the radiator, heat generated in the engine is cooled in the radiator.

In this case, a radiator hose that enables a coolant flow path to be formed by connecting the engine and the radiator is provided, and in an end portion of the radiator hose, a quick connector for easily connecting the radiator hose to the radiator through a clamping operation is provided, and such prior art is illustrated in FIG. 1.

With reference to FIG. 1, when briefly describing a configuration of a quick connector for connecting to a radiator of the prior art, although not illustrated in detail, the quick connector includes an outer case 11 formed in the radiator or for inserting a pre-fastened connection port, a spring for preventing a connection port from deviating, and an O-ring for preventing leakage of coolant, and additionally includes a fixing clip 13 for preventing the quick connector from being separated to the outside of the outer case 11.

According to a quick connector for connecting to a radiator of the prior art, because the connection to the quick connector by the spring is not complete, at least two fixing clips 13 should be separately provided, and when a plurality of fixing clips are individually separated, there is an inconvenient problem that an outer case and a connection port may be separated.

### SUMMARY

The disclosure has been made in view of the above problems and provides a quick connector assembly that can prevent a fluid from leaking by improving the airtightness while separating an outer case and a coupling case from each other without completely separating a fixing member in the process of separating the outer case and the coupling case.

According to various embodiments of the disclosure, a quick connector assembly includes a tube-shaped outer case having a hollow portion therein. An airtight holding member provided inside the hollow portion and coupled to an outer surface of a coupling case so that the outer case and the coupling case inserted into the hollow portion maintain airtightness each other. A fixing member detachably fitting-coupled to the outside of the outer case and configured to elastically press and fix the outer surface of the coupling case inserted into the hollow portion, wherein the fixing member includes a fixing body formed in an erected shape of a character ‘⊏’ and configured to press a coupling case inserted on the hollow portion when both sides thereof enter inside the hollow portion. A first protrusion bent in an outer direction of the fixing body from one side end of the fixing body to be held by an operator so as to move one side end of the fixing body, wherein the first protrusion is movably installed between a first position and a second position positioned at an outer circumferential surface of the outer case, and the fixing body is elastically changed by a movement of the first protrusion.

### BRIEF DESCRIPTION OF THE DRAWINGS

In the drawings, the same or similar reference numerals may be used for the same or similar components.

FIG. 1 is a diagram schematically illustrating a conventional quick connector.

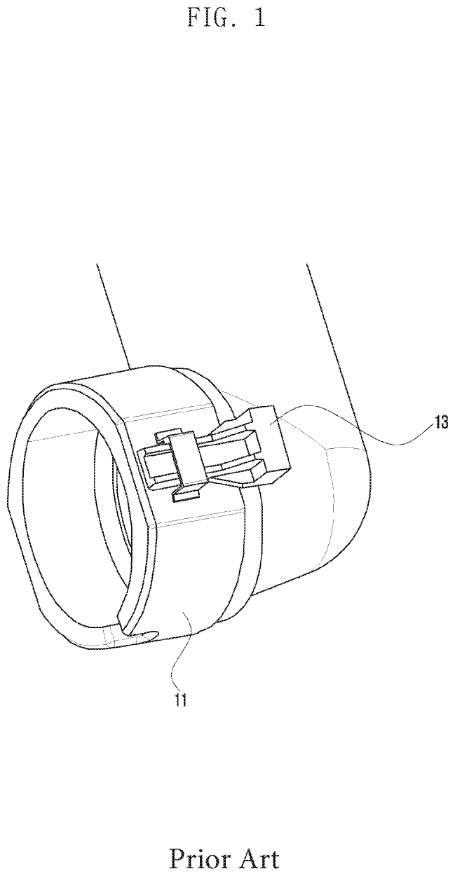

FIG. 2 is a perspective view illustrating a quick connector assembly according to an embodiment of the disclosure.

FIG. 3 is an exploded perspective view of FIG. 2.

FIG. 4 is a perspective view illustrating an airtight holding member and a fixing member installed in an outer case of a quick connector assembly according to an embodiment of the disclosure.

FIG. 5 is a perspective view illustrating a state in which a fixing member is coupled to a coupling body of an outer case according to an embodiment of the disclosure.

FIG. 6 is a diagram illustrating a state in which a fixing member is operated based on an outer case according to an embodiment of the disclosure.

FIG. 7 is a perspective view of FIG. 6.

### DETAILED DESCRIPTION

Hereinafter, exemplary embodiments of the disclosure will be described in detail with reference to the accompanying drawings. The same reference numbers are used throughout the drawings to refer to the same or like parts. Further, detailed descriptions of well-known functions and structures incorporated herein may be omitted to avoid obscuring the subject matter of the disclosure.

It should be noted that a quick connector assembly according to an embodiment of the disclosure can be used for not only a cooling system of a vehicle, but also a portion in which a hose is connected to other parts.

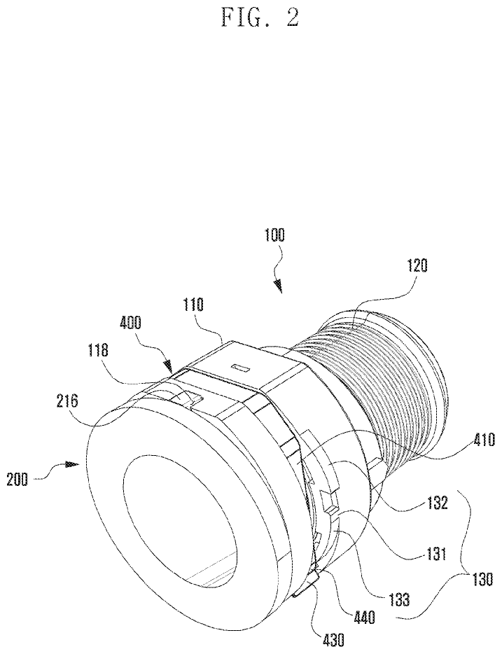

Hereinafter, a quick connector assembly according to an embodiment of the disclosure will be described with reference to FIGS. 2 to 7.

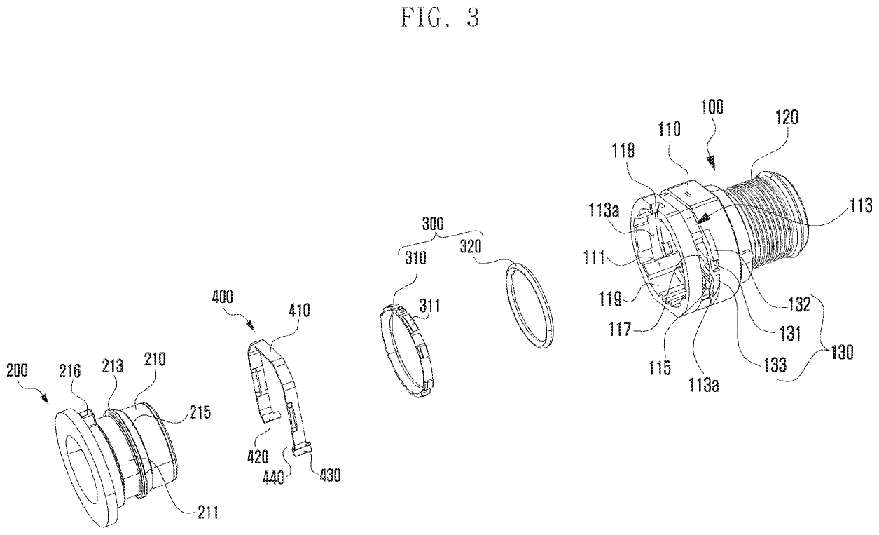

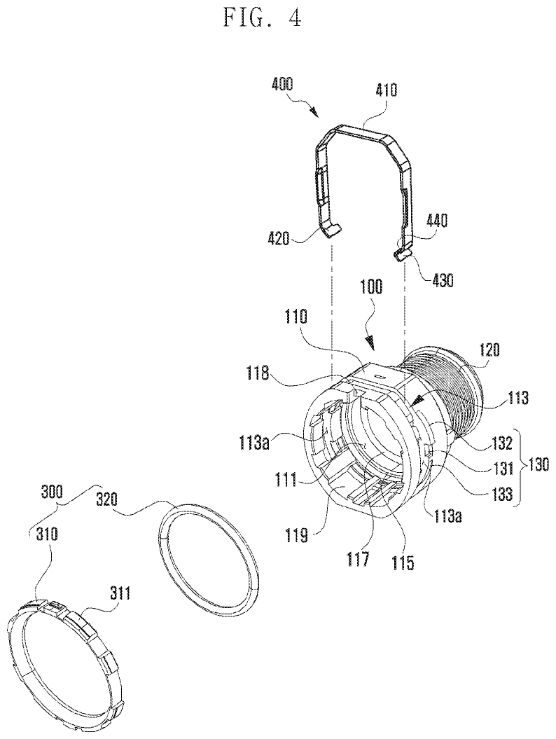

FIG. 2 is a perspective view illustrating a quick connector assembly according to an embodiment of the disclosure. FIG. 3 is an exploded perspective view of FIG. 2, and FIG. 4 is a perspective view illustrating an airtight holding member and a fixing member installed in an outer case of a quick connector assembly according to an embodiment of the disclosure.

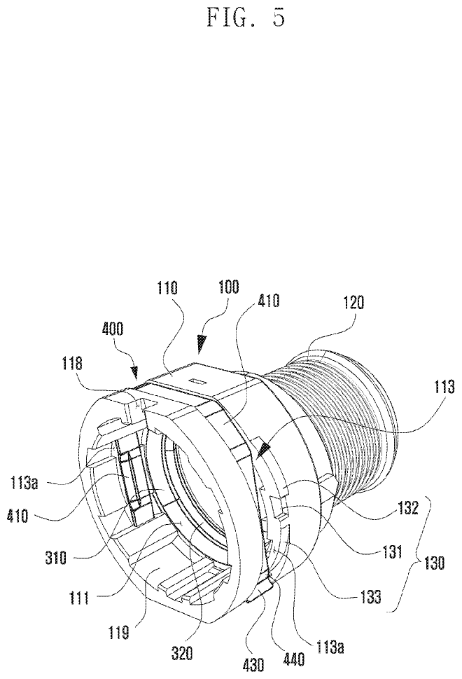

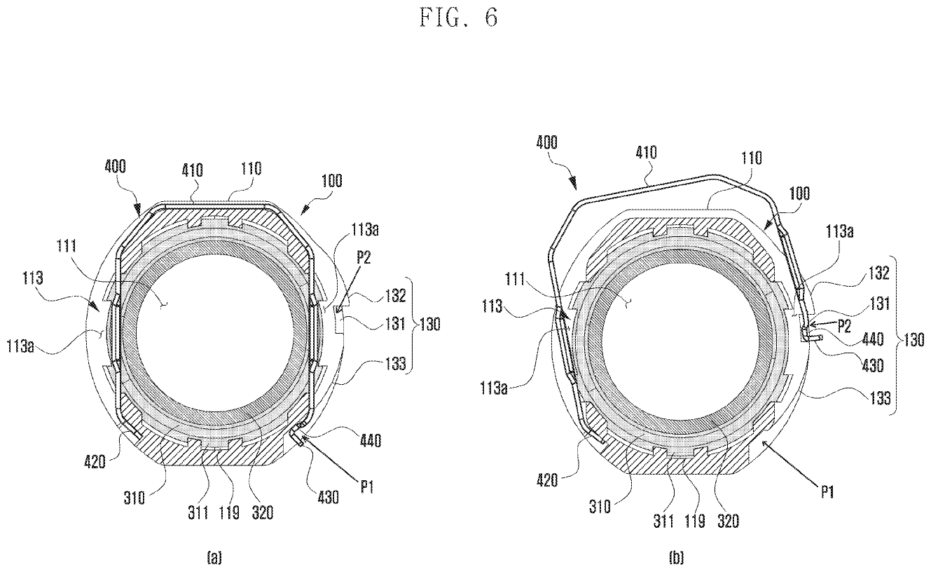

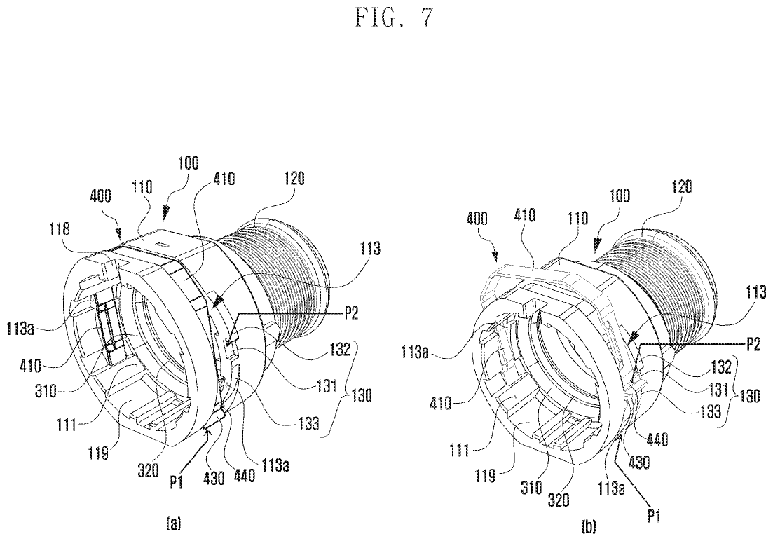

FIG. 5 is a perspective view illustrating a state in which a fixing member is coupled to a coupling body of an outer case according to an embodiment of the disclosure. FIG. 6 is a diagram illustrating a state in which a fixing member is operated based on an outer case according to an embodiment of the disclosure, and FIG. 7 is a perspective view of FIG. 6. Here, FIGS. 6A and 7A illustrate a state before the fixing member is operated, and FIGS. 6A and 7B illustrate a state in which the fixing member is operated to remove a coupling case. With reference to FIGS. 2 and 3, a quick connector assembly according to the disclosure may largely include an outer case 100, an airtight holding member 300, and a fixing member 400.

In more detail, with reference to FIGS. 2-5, a coupling case 200 to be described later is coupled to the outer case 100 and provides a moving path (not illustrated) for moving the fluid by fastening each hose (not illustrated) to be connected to both sides to which the outer case 100 and the coupling case 200 are coupled. Further, the outer case 100 is formed to have a structure in which the fixing member 400 for fixing the coupling case 200 may be coupled. The outer case 100 includes a coupling body 110, an outer body 120 and a locking portion 130.

The coupling body 110 may be formed in a cylindrical tube shape in which a hollow portion 111 is formed in a longitudinal direction, and an inner body 210 of the coupling case 200 to be described later may be inserted and coupled to the hollow portion 111.

In this case, the inner body 210 inserted into the hollow portion 111 preferably maintains airtightness so as to prevent the fluid from flowing to the outside by the airtight holding member 300 to be described later, and the airtight holding member 300 will be described in more detail below.

At an outer surface of the coupling body 110, an insertion groove 113, as shown in FIGS. 4 and 5, may be formed to insert and fix to a fixing body 410 of the fixing member 400 for preventing the inner body 210 inserted into the hollow portion 111 from being separated, and in some areas of both sides of the insertion groove 113, communication holes 113a (see FIGS. 3-5) perforated to communicate the insertion groove 113 and the hollow portion 111 may be each provided. In this case, a width of the insertion groove 113 is preferably formed to be equal to or be slightly larger than that of the fixing body 410 so as to insert the fixing body 410.

Therefore, while both sides of the fixing body 410 coupled to the insertion groove 113 enters each communication hole 113a, the both sides are fitting-coupled by elasticity with the inner body 210 inserted into the hollow portion 111; thus, the inner body 210 of the coupling case 200 may be fixed on the hollow portion 111.

As shown in FIG. 3, an anti-rotation groove 115 may be formed at an inner surface of the coupling body 110 so that the internal body 210 inserted into the hollow portion 111 may be fitting-coupled, and the anti-rotation groove 115 may be fitting-coupled to an anti-rotation projection 213 protruded to the outer surface of the inner body 210 so as to prevent the inner body 210 from rotating or moving on the hollow portion 111.

Further, as shown in FIGS. 3 and 4, an installation groove 117 for enabling a rubber ring 320 of the airtight holding member 300 to be stably detachably installed may be formed at the inner surface of the coupling body 110, and the installation groove 117 may be formed to have a width enough to insert and fix the rubber ring 320 to be described later.

As shown in FIGS. 3-5, at an inner surface of the rear end of the coupling body 110 according to an embodiment of the disclosure, a coupling combination groove 119 for coupling a coupling combination protrusion 311 to be described later may be formed. The coupling combination groove 119 will be described in detail below.

The outer body 120 may be extended from one side end of the coupling body 110, and a hose may be inserted and coupled to an outer surface thereof. More specifically, an outer diameter of the outer body 120 may be coupled and be connected to an inner diameter of the hose in a forced fitting manner, and a moving path for enabling the fluid to move together with the aforementioned coupling body 110 is provided therein.

As shown in FIGS. 2-5, the locking portion 130 may be formed at an outer surface of the coupling body 110 to limit a movement of the first projection so as to detach the coupling case 200 without completely separating the fixing member 400 when separating the fixing member 400 within the insertion groove 113.

In this case, a locking groove 131 (see FIGS. 4, 5, and 6a-b) may be formed in the locking portion 130, and the locking groove 131 may be coupled to lock a locking protrusion 440 in the configuration of the fixing member 400 to be described later; thus, the inner body 210 may be separated from the coupling body 110 without completely separating the fixing member 400 from the coupling body 110. A detailed description thereof will be described in more detail below.

The locking portion 130 may further include a locking piece 132 formed in an upper portion of the locking groove 131 and protruded from an outer surface of the coupling body 110 and a guide piece 133 formed in a lower portion of the locking groove 131 and formed between a first position P1 and a second position P2 as shown in FIGS. 6a-b and in which the locking projection 440 is mounted and moved so as to provide an elastic force to the fixing body 410.

With reference to FIGS. 2, 3, and 5, the coupling case 200 inserted into the hollow portion 111 of the outer case 100 has one side connected to the outer case 100 and the other side coupled to a hose to provide a fluid moving path. The coupling case 200 may include an inner body 210 in which a combination groove 211 is formed.

The inner body 210 is formed in a cylindrical tube shape, and one side of which is inserted into the hollow portion 111 formed in the coupling body 110.

The inner body 210 inserted into the hollow portion 111 is fixed inside the hollow portion 111 when both sides of the fixing body 410 having elasticity press an outer surface of the inner body 210, and for this reason, the combination groove 211 for inserting the fixing body 410 may be formed at the outer surface of the inner body 210. Here, the combination groove 211 may be formed in a band shape along the outer circumferential surface of the inner body 210.

One side of the inner body 210 inserted into the hollow portion 111 may be coupled to a coupling 310 and the rubber ring 320, which are components of the airtight holding member 300, which will be described later, installed in the hollow portion 111.

An outer diameter of one side of the inner body 210 is the same as an inner diameter of the coupling 310, but is formed to have a larger diameter than an inner diameter of the rubber ring 320, thereby improving a fixing force by the coupling 310 together with the fixing member 400 and enabling the airtightness to be maintained by the rubber ring 320.

In this case, an inclined portion 215 corresponding to the inner surface of the coupling 310 is further formed at the outer surface of the inner body 210 coupled to the coupling 310 by the shape fit to be coupled to be close contact with the coupling 310, and the inclined portion 215 may be formed at one side of the anti-rotation protrusion 213.

With reference to FIG. 3, the airtight holding member 300 according to an embodiment of the disclosure may be provided inside the hollow portion 111 and be coupled to the outer surface of the coupling case 200 so that the outer case 100 and the coupling case 200 may maintain airtightness, as described above. The airtight holding member 300 may include a coupling 310 and a rubber ring 320.

The coupling 310 entirely has a ring shape, but may be made of a material such as aluminum or hard plastic to prevent corrosion, and the coupling combination protrusions 311 inserted into a plurality of coupling combination grooves 119, respectively formed at the inner surface of the coupling body 110 may be provided at the outer circumferential surface of the coupling 310.

In this case, the coupling 310 may be fixed on the hollow portion 111 by inserting a plurality of coupling combination protrusions 311 into a plurality of coupling combination grooves 119 (see FIGS. 3-5, 6a-b, and 7a-b) formed at the inner surface of the coupling body 110, and the inner body 210 inserted into the coupling body 110 through the hollow portion 111 may be penetrated and inserted in the shape fit to the coupling 310 to be fixed stably together with the fixing body 410 on the hollow portion 111.

The rubber ring 320 may be entirely formed in a ring shape and be made of a rubber material capable of restoring elasticity having a normal gasket function, and be inserted into the installation groove 117 to enable the outer surface of the inner body 210 to be penetrated and inserted.

As described above, the inner diameter of the rubber ring 320 is formed smaller than the outer diameter of the inner body 210 to be penetrated and inserted; thus, the rubber ring 320 and the inner body 210 are coupled in a forced fitting manner, and the fluid may be prevented from flowing out by the rubber ring 320.

With reference to FIGS. 2, 6 and 7, the fixing member 400 according to an embodiment of the disclosure may easily fix the coupling case 200 inserted into the hollow portion 111 to the coupling body 110, but when separating the inner body 210 of the coupling case 200, the inner body 210 may be separated without completely separating the fixing member 400.

In this case, one side of the fixing member 400 may be movably installed between the first position P1 and the second position P2 positioned at an outer circumferential surface of the outer case 100. Here, the first position P1 is a position in which a first protrusion 430 is disposed in a state in which the fixing member 400 to be described later is inserted into the insertion groove 113, and the second position P2 may be defined as a position in which the locking projection 440 of the fixing member 400 is moved to be caught in the locking groove 131.

The fixing member 400 includes a fixing body 410, a first protrusion 430, a second protrusion 420, and a locking protrusion 440.

The fixing body 410 may be formed to have a predetermined width and, for example, may be entirely made of a material such as a metal having elasticity, but may be formed in a shape in which a character ‘ E’ is erected. The fixing body 410 may be inserted into the insertion groove 113 formed in the coupling body 110.

Both sides of the fixing body 410 inserted into the insertion groove 113 enters inside the hollow portion 111 through each communication hole 113a formed at both sides of the insertion groove 113, and both sides of the fixing body 410 are coupled to the combination groove 211 formed at the outer surface of the inner body 210 by an elastic force to fix the inner body 210 by a pressure.

In this case, the first protrusion 430 and the second protrusion 420 may be provided at both ends of the fixing body 410.

The first protrusion 430 may be bent in an outer direction of the fixing body 410 from one side end of the fixing body 410, and the operator may hold the first protrusion 430 to move the locking protrusion 440 between the first position P1 and the second position P2.

Further, the first protrusion 430 may be installed in close contact with one side of the insertion groove 113 so that one side of the fixing body 410 may be maintained in a state inserted into the insertion groove 113.

The second protrusion 420 may be bent in an inner direction of the fixing body 410 from the other end of the fixing body 410, and be in close contact with the other side end of the insertion groove 113; thus, the other side of the fixing body 410 may be maintained in a state inserted into the insertion groove 113.

The locking protrusion 440 may be protruded at a portion in which the first protrusion 430 and the fixing body 410 are connected, and in a state in which the fixing member 400 is inserted into the insertion groove 113, the fixing member 400 is moved from the first position P1 to the second position P2 to be caught in the locking groove 131.

In this case, when the locking protrusion 440 is caught in the locking groove 131, the inside body 210 may be separated without completely separating the fixing body 410 from the coupling body 110 upon separating the inner body 210 inserted into the hollow portion 111.

More specifically, when it is necessary to separate the coupling case 200 from the outer case 100, if the operator holds the first protrusion 430 and then moves from the first position P1 to the second position P2, while the first protrusion 430 moves, one side of the fixing body 410 is opened while the locking protrusion 440 is mounted on and moves the guide piece 133.

Subsequently, when the operator enables the locking protrusion 440 to be caught in the locking groove 131 formed in the locking portion 130, the fixing body 410 is completely separated from the combination groove 211; thus, the inner body 210 of the coupling case 200 may be separated from the hollow portion 111 of the outer case 100.

In a quick connector assembly according to an embodiment of the disclosure, in order to guide an insertion direction of the inner body 210 inserted into the coupling body 110, a guide groove 118 may be formed at the rear end of the coupling body 110 and a guide protrusion 216 coupled to the guide groove 118 may be formed at the rear end of the inner body 210.

A quick connector assembly according to the disclosure having such a configuration has the effect of easily separating the inner body 210 by rotating the fixing body 410 so that the locking protrusion 440 is caught in the locking groove 131 even without completely separating the fixing body 410 for fixing the inner body 210 inserted into the hollow portion 111 to be connected to the coupling body 110 from the coupling body 110.

A quick connector assembly according to the embodiment of the disclosure can provide work convenience to the maximum to an operator by enabling an outer case and a coupling case to be separated without completely separating a fixing member.

The embodiments of the disclosure disclosed in this specification and drawings only present a specific example in order to easily describe the technical contents according to an embodiment of the disclosure and to help an understanding of the embodiments of the disclosure, and they do not intend to limit the scope of the embodiments of the disclosure. Accordingly, all changes or modifications derived from the technical idea of various embodiments of the disclosure in addition to the embodiments described herein should be construed as being included in the scope of various embodiments of the disclosure without departing from the scope of the disclosure.

[Description of symbols]

| | |
|---|---|
| 100: outer case | 110: coupling body |
| 111: hollow portion | 113: insertion groove |
| 113a: communication hole | 115: anti-rotation groove |
| 117: installation groove | 118: guide groove |
| 119: coupling combination groove | 120: outer body |
| 130: locking portion | 131: locking groove |
| 132: locking piece | 133: guide piece |
| 200: coupling case | 210: inner body |
| 211: coupling groove | 213: anti-rotation projection |
| 215: inclined portion | 216: guide projection |
| 300: airtight holding member | 310: coupling |
| 311: coupling combination protrusion | 320: rubber ring |
| 400: fixing member | 410: fixing body |
| 420: second projection | 430: first projection |
| 440: locking protrusion | P1: first position |
| P2: second position | |

What is claimed is:

1. A quick connector assembly, comprising:
a tube-shaped outer case having a hollow portion therein;
an airtight holding member provided inside the hollow portion and coupled to an outer surface of a coupling case so that the tube-shaped outer case and the coupling case inserted into the hollow portion maintain airtightness with each other; and
a fixing member detachably fitting-coupled to an outside of the tube-shaped outer case and configured to elastically press and fix the outer surface of the coupling case inserted into the hollow portion,
wherein the fixing member comprises:
a fixing body formed in an erected shape of a character ‘⊏’ and configured to press the coupling case inserted into the hollow portion when both sides of the coupling case enter inside the hollow portion; and
a first protrusion bent in an outer direction of the fixing body from one side end of the fixing body to be held by an operator so as to move one side end of the fixing body,
wherein the first protrusion is movably installed between a first position and a second position positioned at an outer circumferential surface of the outer case, and the fixing body is elastically changed by a movement of the first protrusion.

2. The quick connector assembly of claim 1, wherein the outer case comprises:
a coupling body to which the coupling case is coupled and in which an insertion groove into which the fixing member is inserted to fix the coupling case is provided in an outer circumferential surface of the coupling case; and
an outer body extended from one side end of the coupling body and in which a hose is inserted into an outer side surface,
wherein in some regions of both sides of the insertion groove, communication holes communicating with the hollow portion are each provided to enable both sides of the fixing body to enter the hollow portion.

3. The quick connector assembly of claim 2, wherein the outer case further comprises a locking portion formed at an outer surface of the coupling body and comprising a locking groove for limiting a movement of the first projection in order to detach the coupling case without completely separating the fixing member when separating the fixing member within the insertion groove.

4. The quick connector assembly of claim 2, wherein the airtight holding member comprises a rubber ring, and an installation groove, configured to insert and fix the rubber ring, is formed inside the coupling body.

5. The quick connector assembly of claim 3, wherein the fixing member further comprises a locking protrusion protruding in a portion in which the first protrusion and the fixing body are connected and caught in the locking groove when the first protrusion is moved from the first position to the second position.

6. The quick connector assembly of claim 5, wherein the locking portion comprises:
a locking piece formed in an upper portion of the locking groove and protruded from the outer surface of the coupling body; and
a guide piece formed in a lower portion of the locking groove and formed between the first position and the second position, and in which the locking protrusion is mounted and moved so as to provide an elastic force to the fixing body.

7. The quick connector assembly of claim 2, wherein the airtight holding member further comprises a coupling coupled to the outer surface of the coupling case; and
a plurality of coupling combination grooves configured to fix the coupling are formed at the inner surface of the coupling body, and coupling combination protrusions coupled to the coupling combination grooves, respectively are formed at the outer circumferential surface of the coupling case.
